(19) United States
(12) Patent Application Publication
(10) Pub. No.: US 2022/0198217 A1
(43) Pub. Date: Jun. 23, 2022

(54) MODEL PARALLEL TRAINING TECHNIQUE FOR NEURAL ARCHITECTURE SEARCH

(71) Applicant: International Business Machines Corporation, Armonk, NY (US)

(72) Inventors: Lin Dong, Beijing (CN); Chao Xue, Beijing (CN); Jing Li, Beijing (CN); Bin Xu, Beijing (CN)

(21) Appl. No.: 17/130,003

(22) Filed: Dec. 22, 2020

(51) Int. Cl. G06K 9/62; G06N 3/08; G06N 3/04

(52) U.S. Cl. CPC G06K 9/6227; G06N 3/0454; G06N 3/08; G06K 9/6261

(57) ABSTRACT

A model parallel training technique for neural architecture search including the following operations: (i) receiving a plurality of ML (machine learning) models that can be substantially interchangeably applied to a computing task; (ii) for each given ML model of the plurality of ML models: (a) determining how the given ML model should be split for model parallel processing operations, and (b) computing a model parallelism score (MPS) for the given ML model, with the MPS being based on an assumption that the split for the given ML model will be used at runtime; and (iii) selecting a selected ML model based, at least in part, on the MPS scores of the ML models of the plurality of ML models.

### BACKGROUND

The present invention relates generally to the field of machine learning (ML) and more particularly to the field of model parallel distributed training.

US patent application 2019/0188570 (“Lopez”) states, in part, as follows: “Computational units in an artificial neural network (ANN) are modelled after neurons in the human brain, the neurons in the ANN being grouped by layers. Typically, there is an input layer of neurons, an output layer of neurons, and hidden layers of neurons, for example convolution, pooling, rectified linear units, fully connected layers, etc. A Deep Neural Network (DNN) is an ANN with multiple hidden layers of computational units between input and output layers . . . DNNs offer the potential to achieve significant advancements in speech and image recognition, with accuracy performance exceeding those recorded by other sophisticated methods in Machine Learning (ML). However, the training process of DNNs is an extremely computationally intensive task, which typically requires large computational resources, including training (execution) time, and memory (RAM). To address the long training times, state-of-the-art techniques make use of hardware accelerators, including, for example, CPUs . . . , exploiting their vast computational power. However, these accelerators have memory restrictions, as they usually include a limited amount of in-device memory. Such memory restriction poses a problem in situations where the DNN to be trained requires more memory than that available within a single accelerator. In other words, where the parameters and the activations required to train the DNN do not fit into a single accelerator's memory, the process responsible for the training process cannot be performed straightaway. In order to solve this problem, one proposed solution has been to split the parameters of a layer of neurons of the DNN and distribute such parameters across different accelerators, changing the training process accordingly to accommodate the distributed allocation of the weights. This is what is generally called ‘model parallelism’ (as opposed to ‘data parallelism’, where the entire DNN is replicated and stored on all accelerators, processing samples of the training data in parallel . . . ).”

An article published on the internet which is entitled “Model Parallelism in Deep Learning is NOT What You Think” by Saliya Ekanayake and dated 10 Nov. 2018 states as follows: “I've some layers in GPU-0 and others in GPU-1. Is this model parallelism? No, unfortunately, it's not. Like with any parallel program, data parallelism is not the only way to parallelize a deep network. A second approach is to parallelize the model itself. This is where the confusion happens because the layers in a neural network have a data dependency on their previous layers. Therefore, just because you place some of your layers in a different device doesn't mean they can be evaluated in parallel. Instead, what will happen is one device will sit idle while it's waiting for data from the other device. True model parallelism means your model is split in such a way that each part can be evaluated concurrently, i.e. the order does NOT matter. In the above figure, Machine 1 (M1) and Machine 3 (M3) shows how 2 layers are split across devices to be evaluated in parallel. It's the same with Machine 2 (M2) and Machine 4 (M4). However, going from {M1, M3} to {M2, M4} is just splitting your workload because {M2, M4} have to wait on data from {M1, M3} to do any forward pass and vice versa in the backpropagation. Is it Pipeline Parallism? . . . Again, if something to be called parallel it should have elements that can be evaluated concurrently. Pipeline parallelism, as its name suggests, means there is a stream of work items, so each worker always has something to do without having to wait for its previous or successor worker to finish their work. When you partition your network vertically, as shown, technically it is possible to achieve pipeline parallelism. How? Well, you can stream the data items in your minibatch, where one item may be in the forward pass in layer X, while the other item is in the forward pass in layer 1. Of course, now your framework has to support such parallelism, or you have to write it like that from scratch. So it's possible but currently, I am not aware if frameworks actually stream work like this when you partition the model as such.”

An article published on the internet and entitled “Difference Between Algorithm and Model in Machine Learning” by Jason Brownlee, dated Apr. 29, 2020 and last updated on Aug. 19, 2020, states as follows: “Machine learning involves the use of machine learning algorithms and models. For beginners, this is very confusing as often ‘machine learning algorithm’ is used interchangeably with ‘machine learning model.’ Are they the same thing or something different? As a developer, your intuition with ‘algorithms’ like sort algorithms and search algorithms will help to clear up this confusion. In this post, you will discover the difference between machine learning ‘algorithms’ and ‘models.’ After reading this post, you will know: Machine learning algorithms are procedures that are implemented in code and are run on data. Machine learning models are output by algorithms and are comprised of model data and a prediction algorithm. Machine learning algorithms provide a type of automatic programming where machine learning models represent the program.”

### SUMMARY

According to an aspect of the present invention, there is a method, computer program product and/or system that performs the following operations (not necessarily in the following order): (i) receives a plurality of ML (machine learning) models that can be substantially interchangeably applied to a computing task; (ii) for each given ML model of the plurality of ML models: (a) determines how the given ML model should be split for model parallel processing operations, and (b) computes a model parallelism score (MPS) for the given ML model, with the MPS being based on an assumption that the split for the given ML model will be used at runtime; and (iii) selects a selected ML model based, at least in part, on the MPS scores of the ML models of the plurality of ML models.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIGS. 5A, 5B and 5C are diagrams helpful in understanding some embodiments of the present invention;

FIG. 6 is a diagram helpful in understanding some embodiments of the present invention; and

FIGS. 7A, 7B, 7C and 7D are matrices of number values helpful in understanding some embodiments of the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

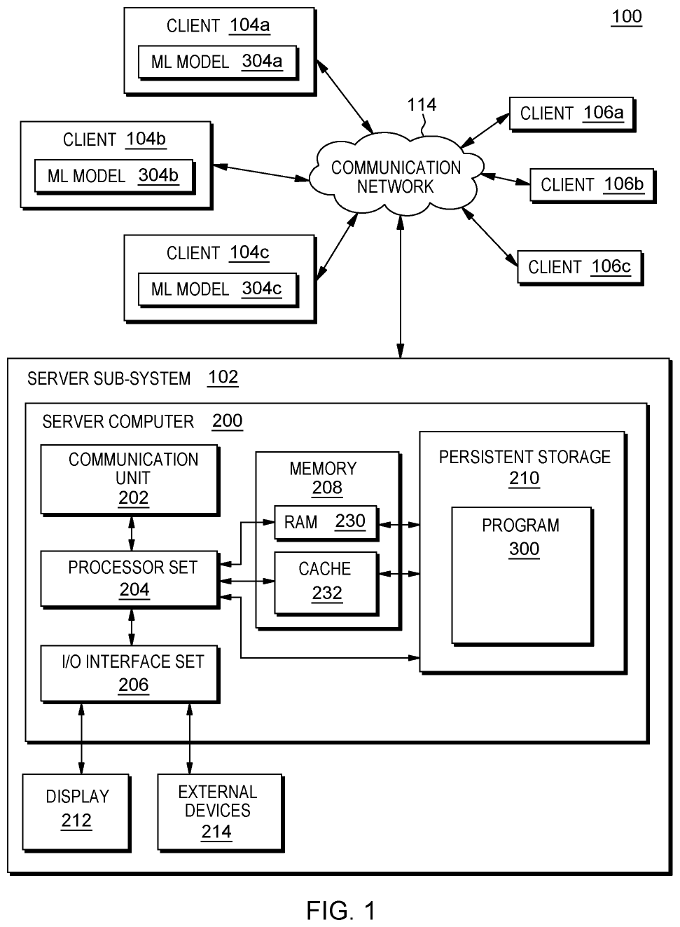

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104a,b,c (may sometimes herein be referred to as the model servers) and 106a,b,c (may sometimes herein be referred to as clients for running parts of the ML model); and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

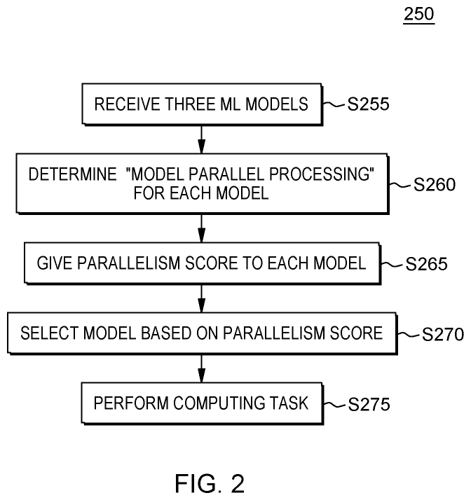

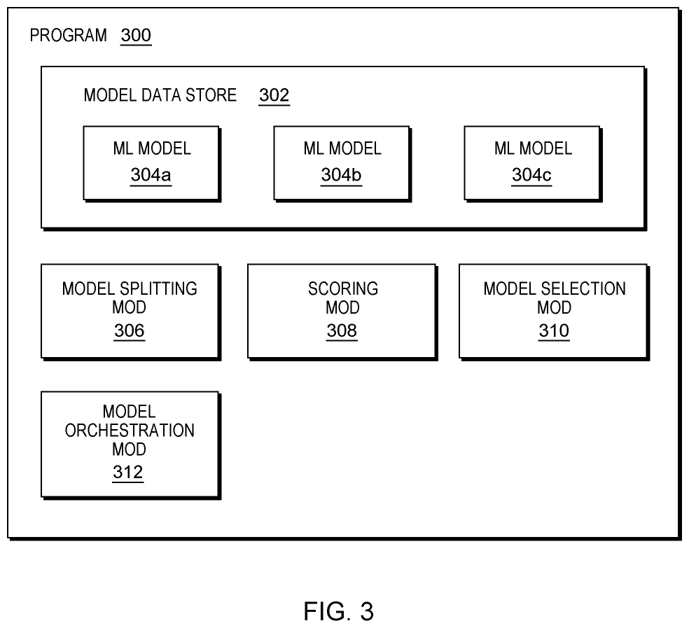

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

Processing begins at operation S255, where ML model data store 302 receives three ML models 304a, b, c that can be substantially interchangeably applied to a computing task (such as making a particular kind of prediction about future event(s). These models are received, respectively from client subsystems 104a, 104b, 104c and through communication network 114. These models are considered as competing models because they are interchangeable for at least some applications.

Processing proceeds to operation S260, where model splitting module (“mod”) 306 determines how each model should be split for “model parallel processing” (see discussion of model parallelism, above, in the Background section).

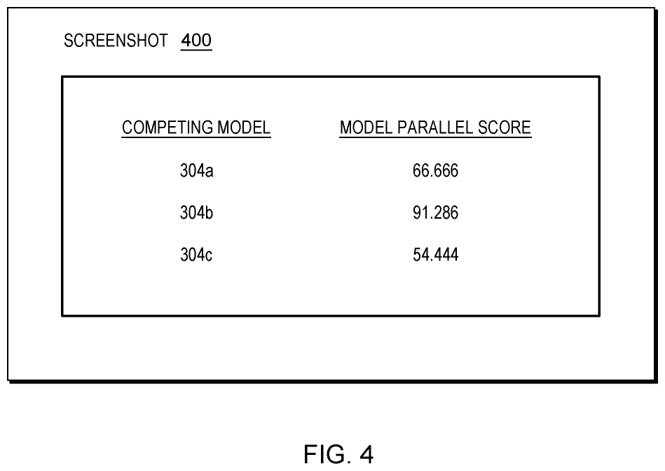

Processing proceeds to operation S265, where scoring mod 308 gives each of the models (304a, b, c) a model parallelism score, based on the respective model breakdowns obtained at the previous operation. This is shown in screenshot 400 of FIG. 4, where, in this example, the model parallelism scores: (i) are between 0 and 100.00; (ii) higher scores are more favorable/better than lower scores; and (iii) the scoring score is linear (as opposed to, for example, logarithmic). In general, a model parallelism score represents how amenable a given model is to being utilized in a “model parallel” manner. More specifically, in this example: (i) the model parallelism score considers whether processing in a parallel manner degrades accuracy/precision of results obtained when the model is applied; (ii) considers time efficiency and/or time savings of the model's parallelism; and (iii) considers resource efficiency of the model's parallelism.

Processing proceeds to operation S270, where model selection mod 310 selects a model based at least in part on the model parallelism score obtained at the previous operation. In this example, the machine logic of mod 310 considers all of the following factors: (i) the model parallelism score; (ii) whether the available resources can handle the model (in a parallel manner) and how much those computing resources will cost; and (iii) the amenability of the model to “data parallelism.” Alternatively, other factors, or no other factors, besides model parallelism score, can be considered in selecting the ML model to be used. In this example, ML model 304b is chosen, largely because it has the best model parallelism score of the three (3) competing ML models.

Processing proceeds to operation S275 where model orchestration mod 312 performs the computing task so that: (i) one portion of selected model 304a runs on client subsystem 106a; (ii) one portion of selected model 304b runs on client subsystem 106b; and (iii) one portion of selected model 304c runs on client subsystem 106c. This parallel way of running model 304b accords with the three-way split determined previously at operation S260.

### III. Further Comments and/or Embodiments

Some embodiments of the present invention recognize one, or more, of the following facts, potential problems and/or potential areas for improvement with respect to the current state of the art: (i) model parallel distributed training involves the following method: (a) providing a model, (b) splitting the model into different parts, and (c) distributing the various parts among and between at different workers; (ii) because of the limit of the model architecture itself, most of the time, it is difficult to achieve high speed up compared with data parallel distributed training; and/or (iii) instead, model parallel was used as a mechanism to solve the problem when the model size is too big to place on one device.

Some embodiments of the present invention may include one, or more, of the following operations, features, characteristics and/or advantages: (i) provides model parallel training for the purpose of increasing the speed of distributed training; (ii) uses automated machine learning to search a model, which is “friendly” for model parallel distributed training, so the limit of the model architecture is broken at the beginning; (iii) here the word “friendly” is mean that it is relatively easy to split the model to be distributed among and between multiple different workers in parallel; (iv) in some embodiments, it is this ease and speed of splitting the model thereby speeds up the entire process of model parallel distributed training; (v) defines a regression neural network to predict a parallelism score of those intermediate models (that is, models generated at an intermediate points in the process of searching for an optimal model) during automated machine learning searching phase, instead of just using the model optimization target such as loss/accuracy; (vi) takes this parallelism score into consideration to optimize the automated machine learning search algorithm/engine; and/or (vii) use the Pareto Oriented Method to combine these two targets (that is, the model optimization target and the target of maximum parallelism) together; (viii) defines a mechanism to discover which model, of selected from among multiple candidates, can best leverage model parallelism to speed up training through automated neural architecture search; and/or (ix) designs a model to estimate the model parallelism score which be used to optimize the automated search algorithm.

Some embodiments of the present invention may include one, or more, of the following operations, features, characteristics and/or advantages: (i) uses search strategies to discover which model, from among multiple candidates, is suitable to train with model parallel mechanism and enjoying the benefit of sped up distributed training; (ii) leverages Neural Architecture Search to build deep learning model which is good for model parallel distributed training; (iii) solves the limits of speed up that normally limit model parallel distributed training by providing a solution based on the model architecture; (iv) takes model parallel distributed training speed up as an objective; and/or (v) defines a method to achieve this through neural architecture search.

To reduce the training time of deep neural network, normally distributed model training is introduced, including data parallel distributed training which splits the training sample in each iteration across multiple workers and model parallel distributed training which splits the model across multiple workers. Model parallel will place different subsets of the model architecture on each workers and data or feature will flow across the workers. However, no matter what expert or automated methods used to design model parallel mechanism across multiple workers, but there are limits of the model architecture itself, and this is why model parallelism actually been used more to solve GPU (graphics processing unit) insufficiency issues by placing subset of model on different device but the training speed up is not hard to achieve through this. Typically, the primary constraint on speeding up training through model parallel is the model architecture itself. Neural Architecture Search these days been used to find deep neural model automatically, but it now focuses more on how to find a model with the best metrics, such as accuracy or inference latency.

Some embodiments of the present invention may include one, or more, of the following operations, features, characteristics and/or advantages: (i) define a mechanism to discover a model which can leverage model parallelism to speed up training through automated neural architecture search(es); (ii) design a model to estimate a model parallelism score which is used to optimize the automated search algorithm; (iii) takes model parallelism training capability as a factor to optimize the automated neural architecture search; (iv) solves two (2) primary problems to solve as follows: (a) how to evaluate the model parallelism training capability of the selected neural architecture, and (b) how to use model parallelism evaluation result to optimize the search algorithm; (v) the search algorithm here is also normally a deep neural network, like NAS (neural architecture search) will resource a reinforcement learning controller to propose neural architecture; (vi) proposes a neural architecture where the model validates loss/accuracy as reward; (vii) defines model parallelism score as a metric to measure the model parallelism training capability of a particular model; (viii) more specifically, this score represent the maximum speed up gained through model parallelism distributed training; (ix) a pre-trained regression model is used to predict this score; and/or (x) a CNN (convolutional neural network) based deep neural network acts as the regression model with the model architecture as its input.

In some embodiments, the trained regression model defines the model training input as follows: (i) X: (Neural Graph Adjacency matrix, Neural Graph Vertex Degree matrix, Neural Graph Data flow matrix); (ii) Y: Model parallelism score, also known as maximum speed up; and (iii) the deep neural network is taken as a graph and different matrix, as will be further discussed below.

In some embodiments, to prepare the training data, besides the existing well know models, random models can be generated with different sizes, based on best practices for model parallel distributed training, and the maximum speed up gain is recoded accordingly. In some embodiments, the pre-trained regression model is used to predict the parallelism score of the proposed model architecture during automated neural architecture searching. In some embodiments, a mechanism is then defined to include this parallelism score to optimize the search algorithm so it discovers “Model Parallel Training Favorable neural architectures.” In some embodiments, the Pareto Oriented Method to accomplish this.

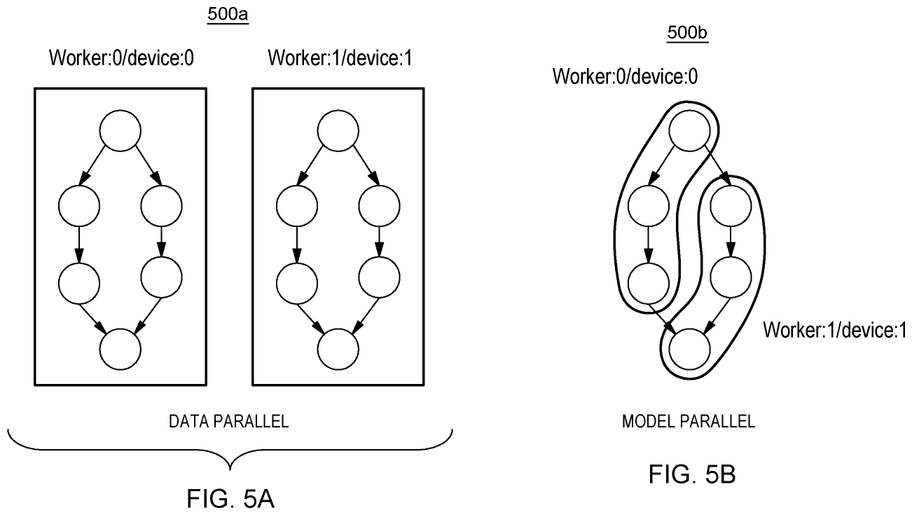

Problem statement and background will now be discussed. To reduce the training time of deep neural network, normally distributed model training will be introduced, including data parallel distributed training which splits the training sample in each iteration across multiple workers and model parallel distributed training which splits the model across multiple workers. Model parallel will place different subsets of the model architecture on each workers and data or feature will flow across the workers. The previous sentence may be better understood by comparing data parallel diagram 500a of FIG. 5A with model parallel diagram 500b of FIG. 5B. However, no matter what expert or automated methods used to design model parallel mechanism across multiple workers, there are limits inherent in the model architecture itself. This is why model parallelism actually has been used more to solve GPU insufficiency issues, specifically by placing a subset of a model on a different computer. A training speed increase can be achieved through this technique. As shown in diagram 500c of FIG. 5C, there is too much dependency between nodes j, k, m, n, so no matter how the model is split into parallel subsets, there is no way to run different subsets of the model in parallel. So, the primary constraints to speed up training through model parallel is the model architecture itself. Neural Architecture Search has been used to find a deep neural model automatically, but is now more focused on how to find a model with the best metric, such as accuracy or inference latency.

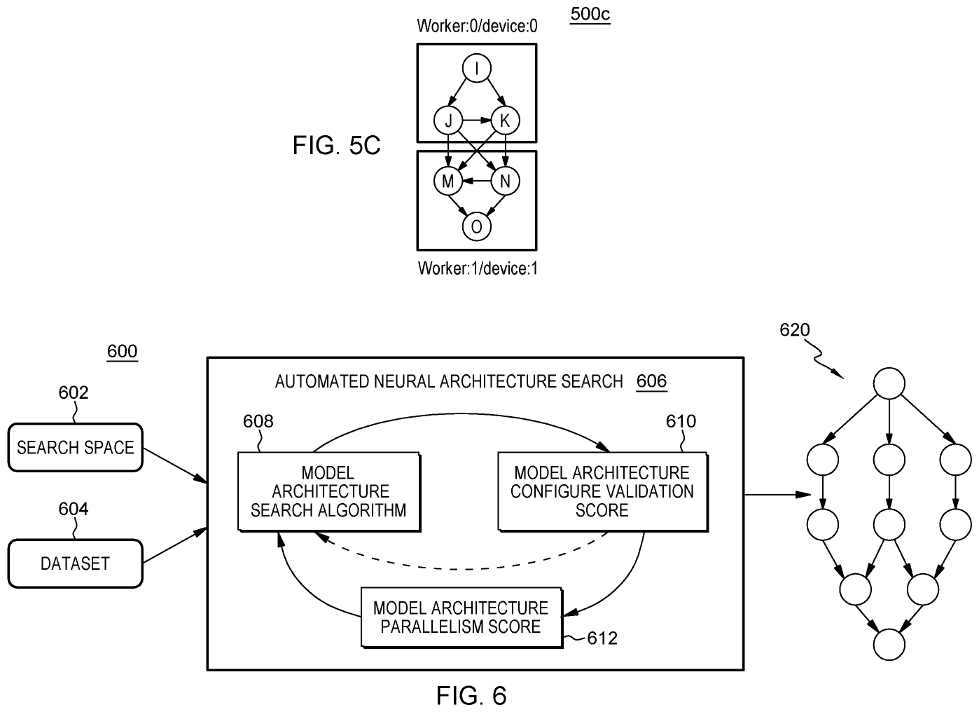

As shown in FIG. 6, diagram 600, includes search space block 602; dataset 604; automated neural architecture block 606 (including model architecture search algorithm 608, model architecture configure validate score 610 and model architecture parallelism score 612); and final selected model architecture 620.

Block 602 represents pre-defined neural network block choices, which can be used to build complete neural network structure. The whole purpose is to find a best model architecture with a proper combination of the block choices. It does not mean that all the blocks should be used in the final model architecture.

Block 604 defines the problem the model architecture is built to solve and will be used to evaluate the model architecture performance.

Block 606 defines the key flow to search model architecture in co-ordination with blocks 602 and 604.

Block 608 proposes candidate combinations of the block choices. These combinations will then be evaluated for their performance and the performance will be considered into next proposals of the search algorithm.

Block 610 evaluates the regular performance (accuracy, loss, etc.) of the model architecture with a normal training job.

Block 612 takes the performance of the capability for model parallel distributed training, and defines a parallelism score for the model architecture.

Block 620 is a dummy sample of the final model architecture found through block 606. Block 620 is the target of block 606, which is to find a model architecture with good regular performance and a good parallelism score.

Some embodiments of the present invention may include one, or more, of the following operations, features, characteristics and/or advantages: (i) defines model parallelism score as a metric to measure the model parallelism training capability of a particular model; (ii) more specifically, this score represent the maximum speed up gained through model parallelism distributed training; (iii) a pre-trained regression model is used to predict this score; (iv) A CNN based deep neural network acts as the regression model with the model architecture as its input; and/or (v) Score[parallelism]=F(architecture). In some embodiments, model architecture leads to a determination of CNN Backbone, which, in turn, leads to FC (fully connected) layers, which, in turn, is used to calculate the model parallelism score.

In some embodiments: (i) to train this regression model, define the model training input as follows: (a) X: (Neural Graph Adjacency matrix, Neural Graph Vertex Degree matrix, Neural Graph Data flow matrix), (b) Y: Model parallelism score, also known as maximal speed up; (ii) deep neural network can be taken as a graph and different matrix; and (iii) to prepare the training data, besides the existing well known models, some embodiments randomly generate models with different size, manual split them with best practice for model parallel distributed training, recode the maximal speed up gained accordingly.

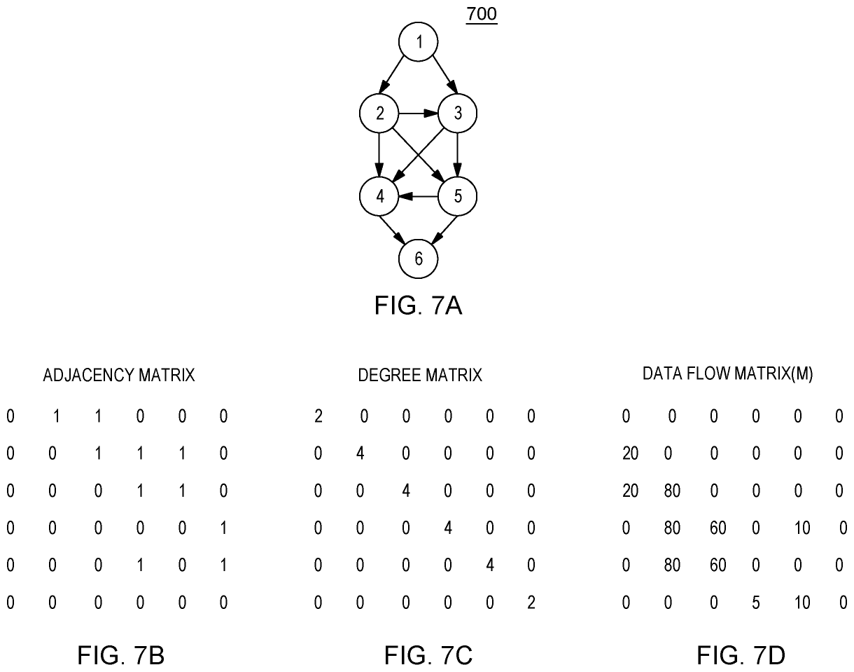

FIG. 7A shows diagram 700, which represents an example model architecture to demonstrate the method to embed model architecture for papalism score calculation, circles represent neural cells/layers, arrows show the connection from one cell/layer to another and how training data flows in the model architecture. FIG. 7B shows an example of an adjacency matrix, which indicates there is a connection start from the node (cell/layer), row index is the node id. Zero (0) means “no connection.” FIG. 7C shows an example of a degree matrix. The numbers represent the out-degree from the node (cell/layer). The row index is the node id. FIG. 7D shows an example of a data flow matrix (M), which represents the size of feature data flow into a node (cell/layer), row index is the node id. Taken together FIGS. 7A to 7D show an example deep neural network can be taken as a graph and different matrix.

In some embodiments: (i) the pre-trained regression model is used to predict the parallelism score of the proposed model architecture during automated neural architecture search; (ii) then a mechanism is defined to include this parallelism score to optimize the search algorithm so it discovers Model Parallel Training Favorable neural architectures; and/or (iii) the Pareto Oriented Method is used to accomplish this.

Some embodiments of the present invention may include one, or more, of the following operations, features, characteristics and/or advantages: (i) invent a method to find model architecture intended for model parallel training; (ii) first time to use automated machine learning to discover model parallel training favorable neural architecture; and/or (iii) break through the limits of model parallel training on the well-defined neural architecture.

Basically, currently conventional automated machine learning still focuses on how to discover a model with good accuracy. Model parallelism focuses on how to split the model architecture. Some embodiments of the present invention bring them together and fit this empty in AutoML area. This is an example of “model parallelism distributed training which is defined as: (i) splitting the model (in the manner of block 620 discussed above) into different parts, and (ii) running the various portions of the model in parallel (that is, at substantially the same time, but using different processors, different processor cores, different processor threads and/or within different containerized virtualized computing environments).

Some embodiments of the present invention are applied to attempt to find a ML algorithms which can be trained in model parallel and output a ML model. While some individuals will also call ML algorithms as training model and ML model as the inference model, for purposes of this document, it is just the name of same thing at different phase of a ML flow.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

What is claimed is:

1. A computer-implemented method (CIM) comprising:
receiving a plurality of ML (machine learning) models that can be substantially interchangeably applied to a computing task;
for each given ML model of the plurality of ML models:
determining how the given ML model should be split for model parallel processing operations, and
computing a model parallelism score (MPS) for the given ML model, with the MPS being based on an assumption that the split for the given ML model will be used at runtime; and
selecting a selected ML model based, at least in part, on the MPS scores of the ML models of the plurality of ML models.

2. The CIM of claim 1 wherein the selection of the selected ML model is further based, at least in part, upon whether currently available computing resources can handle the selected model in a parallel manner according to the split determined for the selected parallel model.

3. The CIM of claim 1 wherein the selection of the selected ML model is further based, at least in part, upon cost of computing resources needed to run the selected ML model.

4. The CIM of claim 1 wherein the selection of the selected ML model is further based, at least in part, upon amenability of the selected ML model to data parallelism.

5. The CIM of claim 1 further comprising:
performing the computing task using the selected ML model using the split determined for the selected ML model.

6. A computer program product (CPP) comprising:
a set of storage device(s); and
computer code stored collectively in the set of storage device(s), with the computer code including data and instructions to cause a processor(s) set to perform at least the following operations:
receiving a plurality of ML (machine learning) models that can be substantially interchangeably applied to a computing task,
for each given ML model of the plurality of ML models:
determining how the given ML model should be split for model parallel processing operations, and
computing a model parallelism score (MPS) for the given ML model, with the MPS being based on an assumption that the split for the given ML model will be used at runtime; and
selecting a selected ML model based, at least in part, on the MPS scores of the ML models of the plurality of ML models.

7. The CPP of claim 6 wherein the selection of the selected ML model is further based, at least in part, upon whether currently available computing resources can handle the selected model in a parallel manner according to the split determined for the selected parallel model.

8. The CPP of claim 6 wherein the selection of the selected ML model is further based, at least in part, upon cost of computing resources needed to run the selected ML model.

9. The CPP of claim 6 wherein the selection of the selected ML model is further based, at least in part, upon amenability of the selected ML model to data parallelism.

10. The CPP of claim 6 wherein the computer code further includes instructions for causing the processor(s) set to perform the following operation(s):
performing the computing task using the selected ML model using the split determined for the selected ML model.

11. A computer system (CS) comprising:
a processor(s) set;
a set of storage device(s); and
computer code stored collectively in the set of storage device(s), with the computer code including data and instructions to cause the processor(s) set to perform at least the following operations:
receiving a plurality of ML (machine learning) models that can be substantially interchangeably applied to a computing task,
for each given ML model of the plurality of ML models:
determining how the given ML model should be split for model parallel processing operations, and
computing a model parallelism score (MPS) for the given ML model, with the MPS being based on an assumption that the split for the given ML model will be used at runtime; and
selecting a selected ML model based, at least in part, on the MPS scores of the ML models of the plurality of ML models.

12. The CS of claim 11 wherein the selection of the selected ML model is further based, at least in part, upon whether currently available computing resources can handle the selected model in a parallel manner according to the split determined for the selected parallel model.

13. The CS of claim 11 wherein the selection of the selected ML model is further based, at least in part, upon cost of computing resources needed to run the selected ML model.

14. The CS of claim 11 wherein the selection of the selected ML model is further based, at least in part, upon amenability of the selected ML model to data parallelism.

15. The CS of claim 11 wherein the computer code further includes instructions for causing the processor(s) set to perform the following operation(s):
performing the computing task using the selected ML model using the split determined for the selected ML model.
